(19) United States
(12) Patent Application Publication
(10) Pub. No.: US 2023/0008038 A1
(43) Pub. Date: Jan. 12, 2023

(54) PACKAGING COMPRISING SEEDS

(71) Applicant: SINOMAX USA INC., Houston, TX (US)

(72) Inventor: JOHN BELIVEAU, Morrisville, NC (US)

(73) Assignee: SINOMAX USA INC., Houston, TX (US)

(21) Appl. No.: 17/849,499

(22) Filed: Jun. 24, 2022

Related U.S. Application Data
(60) Provisional application No. 63/220,398, filed on Jul. 9, 2021.

(51) Int. Cl. B65D 77/24; B65D 81/36; B65B 25/02; A01C 1/04

(52) U.S. Cl. CPC B65D 77/24; B65D 81/36; B65B 25/02; A01C 1/04

(57) ABSTRACT

A packaging article comprising a wall having an outer surface and an inner surface is disclosed along with methods of forming the packaging article. A first patch consisting essentially of an adhesive and one or more materials that biodegrade within about 6 months include a first seed associated therewith. The first patch is adhered to the inner surface of the packaging article and is removable therefrom without a use of a tool, by a human being. The first seed is configured to remain associated with the first patch after removal of the first patch from the inner surface, and the first seed has at least a 50% likelihood of germinating within thirty days after deployment of the first patch under at least about one inch of soil under climatic and meteorological conditions appropriate for germination of the first seed.

### BACKGROUND OF THE INVENTION

### Field of the Invention

Generally, the present disclosure relates to packaging, and, more specifically, to packaging comprising seeds.

### Description of the Related Art

It is generally desirable, for one or more of manufacturing cost savings, positive associations in the public mind, and regulatory compliance, for providers of consumer goods to promote reductions in the environmental footprints of the manufacturing, transport, purchase, and/or use of such goods. “Environmental footprint” is a catch-all for metrics that are generally considered to reflect how “anti-environment” a good, service, or behavior is. Actions that are generally considered to reduce a good or service's “environmental footprint” include, but are not limited to, reduction of CO₂ emissions, performing CO₂ abatement actions (e.g., planting trees), repurposing acreage for “pro-environment” uses (e.g., preservation of old-growth forest or rainforest, reforestation or other rewilding of lands formerly used for human economic activity, repurposing of farmland for organic agriculture, adoption of sustainable forestry techniques, etc.), donations to non-governmental associations (NGOs) that profess pro-environment policies, etc.

One avenue in which a product's environmental footprint can be reduced, and which is highly visible to consumers, is in the packaging of such consumer goods. The experience of seeing packaging labeled to specify certain percentages of recycled and/or post-consumer content is common to consumers in North America, Western Europe, and comparable highly developed economies. Another common experience is seeing packaging labeled to encourage consumers to submit the packaging for recycling after use.

That said, the mere encouragement of recycling by producers of packaging articles may be perceived as a relatively meager reduction in a packaging article's environmental footprint.

Accordingly, it would be desirable to provide packaging articles with reduced environmental footprints.

### SUMMARY OF THE INVENTION

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

In one embodiment, the present disclosure is directed to a packaging article, comprising a wall having an outer surface configured to be visible to consumers and an inner surface configured to secure a product; a first patch consisting essentially of an adhesive and one or more materials that biodegrade within about 6 months when deployed under at least about one inch of soil in a temperate climate; and a first seed associated with the first patch; wherein the first patch is adhered to the inner surface; the first patch is removable from the inner surface.

In one embodiment, the present disclosure is directed to a packaging article, comprising: a wall having an outer surface configured to be visible to consumers and an inner surface configured to secure a product; a first patch consisting essentially of an adhesive and one or more materials that biodegrade within about 6 months when deployed under at least about one inch of soil in a temperate climate; and a first seed associated with the first patch; a second patch consisting essentially of an adhesive and one or more materials that biodegrade within about 6 months when deployed under at least about one inch of soil in a temperate climate; and a second seed associated with the second patch; wherein the first patch and the second patch are each adhered to the inner surface; the first patch and the second patch are each removable from the inner surface, without a use of a tool, by a human being having the manual strength of a 5th percentile woman; the first seed is configured to remain associated with the first patch after removal of the first patch from the inner surface; the second seed is configured to remain associated with the second patch after removal of the second patch from the inner surface; and the first seed and the second seed each has at least a 50% likelihood of germinating within thirty days after deployment of the patch associated with that seed under at least about one inch of soil under climatic and meteorological conditions appropriate for germination of that seed.

In one embodiment, the present disclosure is directed to a method, comprising forming a packaging article comprising a wall having an outer surface configured to be visible to consumers and an inner surface configured to secure a product; forming a first patch consisting essentially of an adhesive and one or more materials that biodegrade within about 6 months when deployed under at least about one inch of soil in a temperate climate; and associating a first seed with the first patch; and adhering the first patch to the inner surface; wherein the first patch is removable from the inner surface, without a use of a tool, by a human being having the manual strength of a 5th percentile woman; the first seed is configured to remain associated with the first patch after removal of the first patch from the inner surface; and the first seed has at least a 50% likelihood of germinating within thirty days after deployment of the first patch under at least about one inch of soil under climatic and meteorological conditions appropriate for germination of the first seed.

The present disclosure may provide packaging articles with reduced environmental footprints relative to packaging articles not comprising seeds.

### BRIEF DESCRIPTION OF THE DRAWINGS

The disclosure may be understood by reference to the following description taken in conjunction with the accompanying drawings, in which like reference numerals identify like elements, and in which:

FIG. 1 presents a stylized perspective view of a packaging article, in accordance with embodiments herein.

FIG. 2 presents a stylized perspective view of a packaging article, in accordance with embodiments herein.

FIG. 3 presents a stylized perspective view of a packaging article, in accordance with embodiments herein.

FIG. 4 presents a stylized side cross-sectional view of a wall of a packaging article and a patch, in accordance with embodiments herein.

FIG. 5 presents a stylized side cross-sectional view of a wall of a packaging article and a patch, in accordance with embodiments herein.

FIG. 6 is a flowchart of a method, in accordance with embodiments herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION

Various illustrative embodiments of the disclosure are described below. In the interest of clarity, not all features of an actual implementation are described in this specification. It will, of course, be appreciated that, in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The present subject matter will now be described with reference to the attached figures. Various structures, systems and devices are conceptually depicted in the drawings for purposes of explanation only and to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Embodiments herein are directed to packaging articles with reduced environmental footprints relative to prior packaging articles. This reduced environmental footprint may arise by providing consumers with easy and convenient supplies of seeds to plant, thereby increasing green cover and reducing atmospheric CO₂ levels by promoting photosynthesis.

In one embodiment, the present disclosure relates to a packaging article, comprising a wall having an outer surface configured to be visible to consumers and an inner surface configured to secure a product; a first patch consisting essentially of an adhesive and one or more materials that biodegrade within about 6 months when deployed under at least about one inch of soil in a temperate climate; and a first seed associated with the first patch; wherein the first patch is adhered to the inner surface.

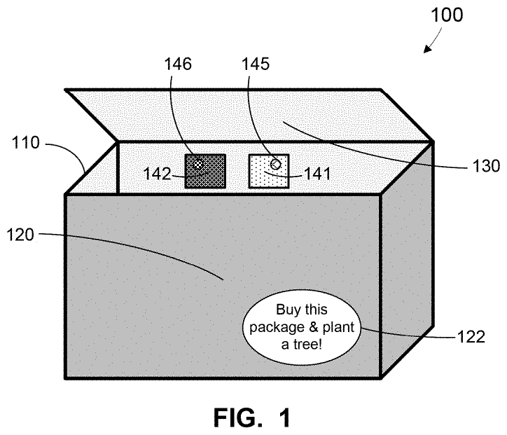

The phrase “packaging article,” as used herein, means any article configured for securing a product for transport and/or sale. With reference to FIG. 1, a typical packaging article 100 comprises a wall 110 having an outer surface 120 configured to be visible to consumers and an inner surface 130 configured to secure a product. In some embodiments, the packaging article may comprise biodegradable material, while in other embodiments, the packaging article may comprise non-biodegradable material.

The product may be any product for which commerce is desired. In one embodiment, the product may be selected from mattresses, pillows, computers, televisions, audiovisual equipment, appliances, or furniture.

The wall 110 may comprise any suitable material presently known or hereinafter developed. In one embodiment, the wall 110 may comprise paperboard, cardstock, cardboard, corrugated cardboard, plastic, metal, or two or more thereof. In an exemplary embodiment, not shown, the wall 110 may comprise one or more windows covered by a transparent material, such as a transparent plastic, with the remainder of the packaging article comprising paperboard, cardstock, cardboard, corrugated cardboard, and/or an opaque plastic. Alternatively, or in addition, in another exemplary embodiment, also not shown, the wall 110 may comprise one or more windows not covered by any material, thereby permitting a user to touch the product, activate a demonstration of a feature of the product, or the like.

Regardless of the particular material(s) the wall 110 may comprise, the wall 110 may comprise recycled material. For example, the packaging article may comprise at least about 5% recycled material; at least about 10% recycled material; at least about 15% recycled material; at least about 20% recycled material; at least about 25% recycled material; at least about 30% recycled material; at least about 35% recycled material; at least about 37.5% recycled material; at least about 40% recycled material; at least about 45% recycled material; at least about 50% recycled material; at least about 55% recycled material; at least about 60% recycled material; at least about 65% recycled material; at least about 70% recycled material; at least about 75% recycled material; at least about 80% recycled material; at least about 85% recycled material; at least about 90% recycled material; or at least about 95% recycled material.

In embodiments, the wall 110 may comprise a biodegradable material and/or other types of material.

The wall 110 is not necessarily unitary. The wall 110 may comprise multiple pieces of material joined to one another by one or more of glue, tape, tacks, brads, rivets, screws, staples, cords, threads, strings, laces, paired mating structures (e.g., tabs and slots), etc., as will be apparent to the person of ordinary skill in the art having the benefit of the present disclosure.

In addition to the wall 110, the packaging article 100 comprises a first patch 141 consisting essentially of an adhesive and one or more materials that biodegrade within about 6 months when deployed under at least about one inch of soil in a temperate climate. The phrase “temperate climate,” as used herein means a meteorological regime wherein the ambient temperature remains above 32° F. (0° C.) and the average rainfall is at least 15″ (38.1 cm) for the 6-month period in which biodegradability is assayed. The first patch 141 may biodegrade in less than 6 months in a temperate climate or may biodegrade within 6 months in a subtemperate climate, i.e., a climate wherein the ambient temperature may fall below 32° F. (0° C.) and/or the average rainfall is less than 15″ (38.1 cm) during the 6-month period.

Any material(s) that meet the biodegradability parameter referred to above and other parameters to be discussed below may be used in the first patch 141 as a matter of routine experimentation for the person of ordinary skill in the art having the benefit of the present disclosure.

The first patch 141 also comprises an adhesive. The adhesive is generally disposed on one side of the first patch 141. The adhesive may be selected by the person of ordinary skill in the art having the benefit of the present disclosure from among adhesives suitable for adhering the other material(s) of the first patch 141 to the inner surface 130. Desirably, the adhesive is biodegradable under the same parameters as the other material(s) discussed above.

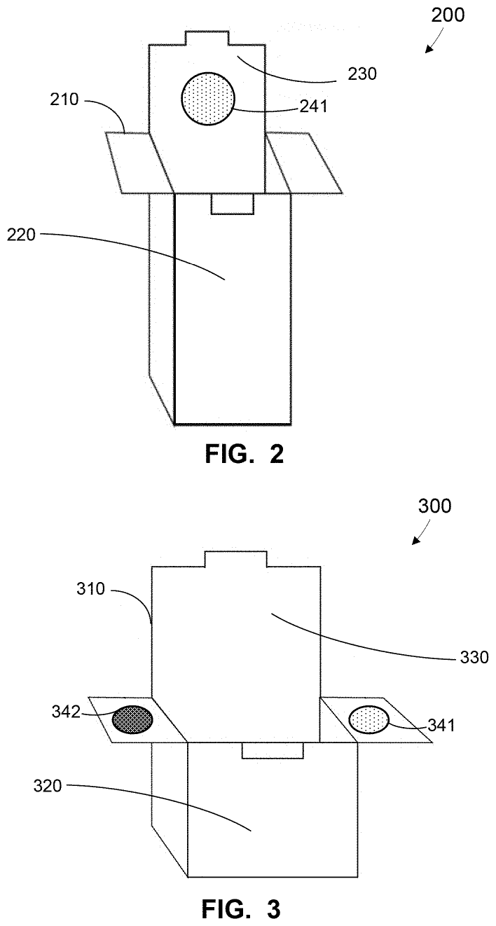

The first patch 141 can be positioned essentially anywhere on the inner surface 130. For convenient access to the first patch 141 by a consumer during or after extraction of a packaged good from the packaging article 100, the first patch 141 may be positioned near the opening of the packaging article 100 (as shown in FIG. 1), on a lid of the packaging article 100 (as shown in FIG. 2), or on a flap of the packaging article 100 (as shown in FIG. 3), among other locations (not shown) that the person of ordinary skill in the art may select as a routine matter.

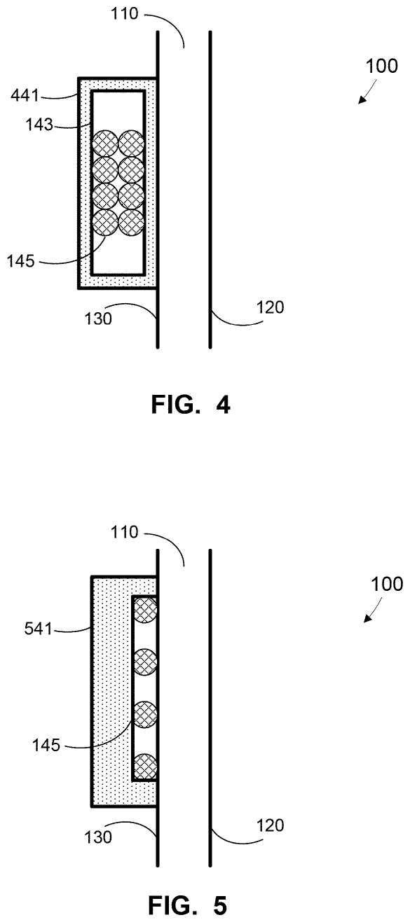

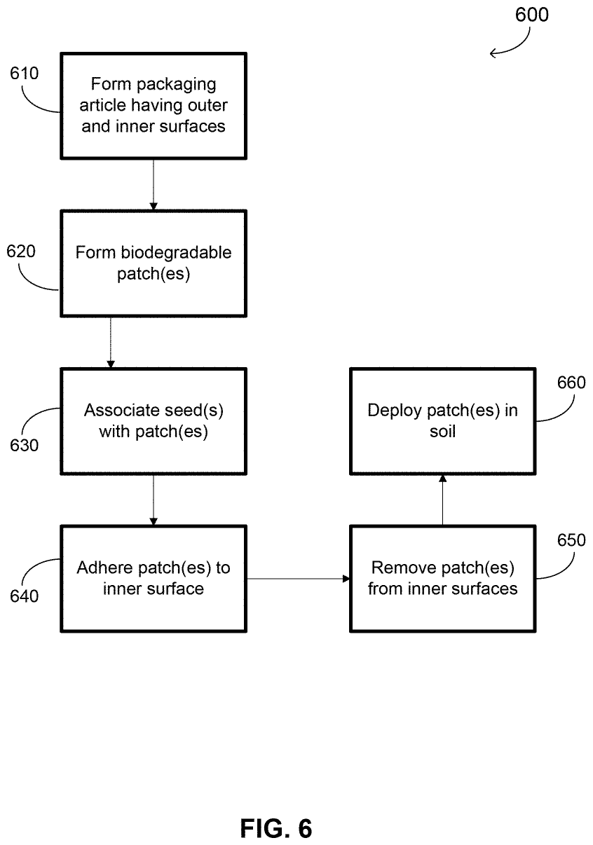

The packaging article 100 also comprises a first seed 145 associated with the first patch 141. The phrase “associated with,” as used herein means that the first seed 145 is either incorporated into a pocket 143 (as shown in FIG. 4), positioned between the first patch 141 and the inner surface 130 (as shown in FIG. 5), embedded in the first patch 141, or the like. In embodiments comprising a pocket 143, the pocket 143 may be maintained in a closed state by an adhesive (which may be the same as the adhesive adhering the first patch 141 to the inner surface 130, but need not be), by heat, by a biodegradable staple, string, or other closure, by folding and tucking a flap, etc. The person of ordinary skill in the art having the benefit of the present disclosure can implement any particular closure for the pocket 143 as a routine matter.

The first seed 145 need not be the only seed associated with the first patch 141. In embodiments, the first seed 145 is one of a first plurality of seeds associated with the first patch 141. These embodiments are conceptually represented in FIG. 4 and FIG. 5. The first plurality of seeds may be each from a same species but need not.

The first seed 145 and any other seeds of a first plurality of seeds may be selected from a tree seed, a flower seed, an ornamental plant seed, a fruit seed, or a vegetable seed. “Fruit seed” and “vegetable seed” are used herein to refer to seeds of plants that are generally grown to produce fruits, or vegetables and/or grains, for human or animal consumption. “Flower seed” is used herein to refer to a seed of a plant that is generally grown to produce flowers, e.g., roses, lilies, orchids, carnations, daisies, etc. “Ornamental plant seed” is used herein to refer to a seed of a plant that is generally grown for esthetic purposes other than the growing of flowers, e.g., plants commonly used in hedges, shrubbery, topiary, lawns, ground cover, etc.

The foregoing descriptions of the first patch 141 and the first seed 145 also apply to a second patch 142 and a second seed 146. For brevity, the second patch 142 and the second seed 146 will not be described further, except to discuss differences between them and the first patch 141 and/or the first seed 145.

The first seed 145 and the second seed 146 may be of the same species or of different species. In one embodiment, the first seed 145 is selected from a tree seed, a flower seed, or an ornamental plant seed, and the second seed 146 is selected from a fruit seed or a vegetable seed.

In embodiments, the packaging article 100 and its components described above satisfy one or more conditions:
(i) the first patch 141 is removable from the inner surface 130, without using a tool, by a human being having the manual strength of a 5th percentile woman. In other words, the first patch 141 may be easily removed from the inner surface 130 by essentially any person without the need of a scraper, tweezers, scissors, etc.
(ii) the first seed 145 is configured to remain associated with the first patch 141 after removal of the first patch 141 from the inner surface 130.
(iii) the first seed 145 has at least a 50% likelihood of germinating within thirty days after deployment of the first patch 141 under at least about one inch of soil under climatic and meteorological conditions appropriate for germination of the first seed 145. Appropriate conditions for germination will vary depending on the first seed, but will be well-known to the person of ordinary skill in the art. A 50% likelihood of germination can be determined by the person of ordinary skill in the art as a matter of routine experimentation.

Likelihood of germination may be affected by soil temperature. In some embodiments, instructions may be provided indicating that the soil condition should be in certain ranges, for example, the soil temperature range should be about 40° F. to 85° F. and an optimum range of about 50° F. to 85° F. for seeds of certain plants such as beet, cabbage, cauliflower, celery, chard, etc. In other embodiment, instructions in the package may indicate that the soil temperature should between 60° F. to 95° F. and an optimum range of about 60° F. to 85° F. for seeds of certain plants, such as cucumber, eggplant, melons, pepper, pumpkin, squash, etc. In yet another embodiment, instructions in the package may indicate that the soil temperature should between 35° F. to 95° F. and an optimum range of about 50° F. to 95° F. for seeds of certain plants, such as onion, parsley, spinach, tomato, etc.

Other factors may also affect the likelihood of germination, such as soil type, soil moisture, soil condition, etc. Instructions may be provided in the package that provide information related to likelihood of germination. In some embodiments, the seeds provided in the package may be customized to certain regions based on expected soil temperatures, soil type, soil moisture, soil conditions, thereby increasing likelihood of germination.

In embodiments such as those shown in FIG. 1 and FIG. 3, the same conditions may hold for the second patch 142 and the second seed 146.

In a particular embodiment, the packaging article 100 may meet all conditions (i)-(iii) for the first patch 141, the first seed 145, the second patch 142 (if included in the packaging article 100), and the second seed 146 (if included in the packaging article 100).

Alternatively, or in addition, in embodiments wherein a plurality of seeds are present in association with the first patch 141 or the second patch 142, there is at least a 95% likelihood that at least one seed of the plurality of seeds will germinate within thirty days after deployment of the patch 141 or 142 under at least about one inch of soil under climatic and meteorological conditions appropriate for germination of the seed 145 or 146.

In embodiments, the packaging article 100 may further comprise one or more other elements. For example, and as depicted in FIG. 1, the packaging article 100 may further comprise one or more elements 122 comprising text or graphics, wherein the element or elements are located on the outer surface 120 and indicate the presence of the first seed 145.

Alternatively, or in addition, the packaging article 100 may comprise instructions (not shown) comprising text or graphics, wherein the instructions are printed on the outer surface 120, the inner surface 130, and/or on an insert positioned inside the packaging article 100, wherein the instructions provide guidance to the consumer about where and how to plant the first seed 145, care for the plant after germination of the first seed 145, etc. In some embodiments, one or more inserts may be used to house the first seed 145 and/or a second seed.

In embodiments wherein the packaging article 100 further comprises text or graphical elements 122, and/or other printed elements, the inks used in the elements 122 or other printed elements may be recycled, recyclable, biodegradable, or two or more thereof.

Alternatively, or in addition, the packaging article 100 may further comprise one or more interior packaging bodies to assist in securing an article inside the packaging article 100. In embodiments, the interior packaging body/ies 240 may comprise paperboard, cardstock, cardboard, corrugated cardboard, plastic, metal, or two or more thereof.

In FIG. 2 through FIG. 5, reference numerals having the same ones and tens digits as a reference numeral shown in FIG. 1 refer to substantially similar elements. The elements will only be described in reference to FIG. 2 through FIG. 5 to the extent they differ from the substantially similar element in FIG. 1.

FIG. 2 depicts a packaging article 200. In this embodiment, the packaging article 200 is configured to secure a pillow. The first patch 241 is present on the inner surface 230 of the lid of the packaging article 200.

FIG. 3 depicts a packaging article 300, in accordance with embodiments herein. The packaging article 300 is configured to secure a mattress topper. The packaging article 300 comprises two patches, a first patch 341 disposed on an interior surface 330 of one flap and a second patch 342 disposed on an interior surface of another flap. The first patch 341 may be in association with fruit or vegetable seeds, and the second patch 342 may be in association with tree, flower, or ornamental plant seeds.

FIG. 6 is a flowchart of a method 600, in accordance with embodiments herein. The method 600 comprises forming (at 610) a packaging article comprising a wall having an outer surface 320 configured to be visible to consumers and an inner surface 330 configured to secure a product. The method 600 also comprises forming (at 620) a first patch 341 consisting essentially of an adhesive and one or more materials that biodegrade within about 6 months when deployed under at least about one inch of soil in a temperate climate.

The method 600 further comprises associating (at 630) a first seed 145 with the first patch 341. Associating (at 630) may comprise inserting the first seed 145 into a pocket of the first patch 441 or positioning the first seed 145 in a position between the first patch 541 and the inner surface 130 prior to adhering (at 640), among other possible actions the person of ordinary skill in the art having the benefit of the present disclosure may implement as a routine matter.

The method 600 additionally comprises adhering (at 640) the first patch 341 to the inner surface 330.

The person of ordinary skill in the art having the benefit of the present disclosure may make routine variations in the actions at 610, 620, 630, and 640, bearing in mind that one or more conditions (i)-(iii) be met. In one embodiment, actions performed at 610, 620, 630, and 640 render the first patch removable from the inner surface, without a use of a tool, by a human being having the manual strength of a 5th percentile woman; the first seed configured to remain associated with the first patch after removal of the first patch from the inner surface; and the first seed having at least a 50% likelihood of germinating within thirty days after deployment of the first patch under at least about one inch of soil under climatic and meteorological conditions appropriate for germination of the first seed.

Alternatively, or in addition, the method 600 may further comprise removing (at 650) the first patch 341 from the inner surface 330, and/or deploying (at 660) the first patch 341 under at least about one inch of soil. Desirably, if deploying (at 660) is performed, removing (at 650) is performed first. Deploying (at 660) is desirably performed under conditions wherein germination of the first seed is more likely than not. The steps 650 and 660 may be performed by the consumer of the package.

The actions performed at 620-640, and optionally 650-660, may also be performed on a second patch and a second seed.

The particular embodiments disclosed above are illustrative only, as the disclosure may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is, therefore, evident that the particular embodiments disclosed above may be altered or modified and all such variations are considered within the scope and spirit of the disclosure. Accordingly, the protection sought herein is as set forth in the claims below.

What is claimed is:

1. A packaging article, comprising:
a wall having an outer surface configured to be visible to consumers and an inner surface configured to secure a product;
a first patch consisting essentially of an adhesive and one or more materials that biodegrade within about 6 months when deployed under at least about one inch of soil in a temperate climate; and
a first seed associated with the first patch;
wherein the first patch is adhered to the inner surface;
the first patch is removable from the inner surface; and
the first seed is configured to remain associated with the first patch after removal of the first patch from the inner surface.

2. The packaging article of claim 1, wherein the first seed has at least one of a 50% or a 95% likelihood of germinating within thirty days after deployment of the first patch under at least about one inch of soil under climatic and meteorological conditions appropriate for germination of the first seed.

3. The packaging article of claim 1, wherein the first patch is removable from the inner surface without a use of a tool, by a human being having the manual strength of at least a 5th percentile woman;

4. The packaging article of claim 2, wherein:
the first seed is one of a first plurality of seeds associated with the first patch; and
the first plurality of seeds are each from a common first species.

5. The packaging article of claim 1, wherein the first seed is selected from a tree seed, a flower seed, an ornamental plant seed, a fruit seed, or a vegetable seed.

6. The packaging article of claim 1, wherein the first patch forms a pocket, and the first seed is disposed inside the pocket.

7. The packaging article of claim 1, wherein the first seed is positioned between the first patch and the inner surface.

8. The packaging article of claim 1, further comprising a first label on the outer surface indicating the presence of the first patch.

9. The packaging article of claim 1, further comprising:
a second patch consisting essentially of an adhesive and one or more materials that biodegrade within about 6 months when deployed under at least about one inch of soil in a temperate climate; and
a second seed associated with the second patch;
wherein the second patch is adhered to the inner surface;
the second patch is removable from the inner surface, without a use of a tool, by a human being having the manual strength of at least a 5th percentile woman;
the second seed is configured to remain associated with the second patch after removal of the second patch from the inner surface; and
the second seed has at least a 50% likelihood of germinating within thirty days after deployment of the second patch under at least about one inch of soil under climatic and meteorological conditions appropriate for germination of the second seed.

10. The packaging article of claim 9, wherein the second seed is one of a second plurality of seeds associated with the second patch.

11. The packaging article of claim 10, wherein the second plurality of seeds are each from a common second species.

12. The packaging article of claim 10, wherein there is at least a 95% likelihood that at least one seed of the second plurality of seeds will germinate within thirty days after deployment of the second patch under at least about one inch of soil under climatic and meteorological conditions appropriate for germination of the second seed.

13. The packaging article of claim 9, wherein the second seed is selected from a tree seed, a flower seed, an ornamental plant seed, a fruit seed, or a vegetable seed.

14. The packaging article of claim 9, wherein the second patch forms a pocket, and the second seed is disposed inside the pocket.

15. The packaging article of claim 9, wherein the second seed is positioned between the second patch and the inner surface.

16. The packaging article of claim 9, further comprising a second label on the outer surface indicating the presence of the second patch.

17. A packaging article, comprising:
a wall having an outer surface configured to be visible to consumers and an inner surface configured to secure a product;
a first patch consisting essentially of an adhesive and one or more materials that biodegrade within about 6 months when deployed under at least about one inch of soil in a temperate climate; and
a first seed associated with the first patch;
a second patch consisting essentially of an adhesive and one or more materials that biodegrade within about 6 months when deployed under at least about one inch of soil in a temperate climate; and
a second seed associated with the second patch;
wherein the first patch and the second patch are each adhered to the inner surface;
the first patch and the second patch are each removable from the inner surface, without a use of a tool, by a human being having the manual strength of a 5th percentile woman;
the first seed is configured to remain associated with the first patch after removal of the first patch from the inner surface;
the second seed is configured to remain associated with the second patch after removal of the second patch from the inner surface; and
the first seed and the second seed each has at least a 50% likelihood of germinating within thirty days after deployment of the patch associated with that seed under at least about one inch of soil under climatic and meteorological conditions appropriate for germination of that seed.

18. A method, comprising:
forming a packaging article comprising a wall having an outer surface configured to be visible to consumers and an inner surface configured to secure a product;
forming a first patch consisting essentially of an adhesive and one or more materials that biodegrade within about 6 months when deployed under at least about one inch of soil in a temperate climate; and
associating a first seed with the first patch; and
adhering the first patch to the inner surface;
wherein the first patch is removable from the inner surface, without a use of a tool, by a human being having the manual strength of a 5th percentile woman;
the first seed is configured to remain associated with the first patch after removal of the first patch from the inner surface; and
the first seed has at least a 50% likelihood of germinating within thirty days after deployment of the first patch under at least about one inch of soil under climatic and meteorological conditions appropriate for germination of the first seed.

19. The method of claim 18, further comprising:
removing the first patch from the inner surface;
deploying the first patch under at least about one inch of soil.

20. The method of claim 18, further comprising:
forming a second patch consisting essentially of an adhesive and one or more materials that biodegrade within about 6 months when deployed under at least about one inch of soil in a temperate climate; and
associating a second seed with the second patch;
adhering the second patch to the inner surface;
wherein the second patch is removable from the inner surface, without a use of a tool, by a human being having the manual strength of a 5th percentile woman;
the second seed is configured to remain associated with the second patch after removal of the second patch from the inner surface; and
the second seed has at least a 50% likelihood of germinating within thirty days after deployment of the second patch under at least about one inch of soil under climatic and meteorological conditions appropriate for germination of the second seed.
